(19) United States
(12) Patent Application Publication
(10) Pub. No.: US 2012/0330749 A1
(43) Pub. Date: Dec. 27, 2012

(54) SYSTEM, METHOD AND COMPUTER PROGRAM PRODUCT FOR MANAGING DIGITAL PROMOTIONAL CONTENT WITH PERSONALIZED USER CONTROL

(76) Inventor: Mark B. Janes, Los Gatos, CA (US)

(21) Appl. No.: 13/490,217

(22) Filed: Jun. 6, 2012

Related U.S. Application Data
(60) Provisional application No. 61/499,558, filed on Jun. 21, 2011.

(51) Int. Cl. G06Q 30/02

(52) U.S. Cl. 705/14.53

(57) ABSTRACT

Embodiments disclosed herein provide new ways for a user to interact, bookmark, store and categorize digital advertising and share specific advertisements and offers with friends. A personal storage and management application, accessible by the user via any Internet-enabled device, can provide the user with an ability to manage and control various types of advertising data received from advertisers as well as personal data available to the advertisers. In one embodiment, the user can collect multiple Internet advertising campaigns and offers, which are categorized and stored into relevant categories for future access and usage. This ability can be beneficial to advertisers as increased engagement with end users can increase the value of advertisement to the advertising industry. It also gives advertisers an effective way of tracking and collecting information about a user based on what the user is willing to provide, creating a one to one relationship with the user.

### TECHNICAL FIELD

This disclosure relates generally to digital advertising, and more particularly, to a viable solution for users to access and manage digital advertisements (ads) relevant to their own needs. In this specification, the term digital advertisement or digital ad for short is meant to encompass, but is not limited to, various forms of promotional content such as coupons, QR (Quick Response) codes, images and videos. Even more particularly, embodiments disclosed herein relate to a system, method, and computer program product for interacting, bookmarking, categorizing and storing digital ads with personalized user control.

### BACKGROUND OF THE RELATED ART

Digital advertising is a form of marketing and includes online advertising which uses a public network such as the Internet to deliver messages about certain products and/or services. Other forms of marketing may include television, radio, print and billboards. Much like buying a space from a newspaper publisher to display an ad (short for advertisement), an advertiser may purchase a space from a publisher to display a digital ad on one or more web pages of one or more web sites or domains owned and operated by that publisher. Of course, the advertiser may have its own web site(s) and anyone with a web presence may be called a Web or online publisher.

Digital ads can be delivered to end users (consumers) in many ways. For example, a digital ad may be delivered in a real time or batch mode, when a user is offline or online, using a push or pull mechanism. The digital ad itself may be a static ad or dynamically assembled in response to an ad request.

One advantage of digital advertising is its ability to be more quantifiable where each digital ad clicked/viewed represents a network transaction between a user's computer or other Internet-enabled device (such as smart phone or tablet) and a web server. These client-server interactions allow an advertiser to measure the performance of each ad and provide a quantifiable way to measure its return on investment.

For example, a banner ad can appear within a webpage or embedded within an application used by a smart phone or tablet. An ad server can monitor and track the deployment and usage of the banner ad delivered to a user device and report on user interaction which may include clicking on links to additional advertising micro sites and which may provide additional detailed information on the advertising campaign associated with the particular banner ad.

Digital ads are typically sold on a Cost per Thousand Impressions (often abbreviated to CPI or CPM) basis, where an impression represents a user's viewing of an ad. As the digital marketplace has become more sophisticated, other advertising pricing structures have also been adopted to charge for the use of advertising inventory. These include Cost per Action—CPA (where the advertiser pays for each specified action such as a purchase or a form submission linked to the advertisement) or Cost per Time—CPT (where the advertiser pays for an advertisement to be placed on a website for a set amount of time). In all cases, results are measured based on the user's interaction with the ad. Ultimately, the performance of a digital ad is based on the user wanting to interact at that moment in time when the ad is served to the user's Internet-enabled device. Thus, the digital advertising industry continues to need new methodologies to increase the value of the user interaction through improved CPM (and other) pricing structures.

One of the greatest challenges that advertisers face today is that government privacy and security policies make it difficult to track and collect information about individual users. Thus, the digital advertising industry also needs new ways to overcome opt-in policies surrounding third party tracker technology that can be placed in the web page to verify how many accesses that page had and the viewing habits of the end user.

### SUMMARY OF THE DISCLOSURE

Embodiments disclosed herein provide a system, method, and computer program product for addressing several challenges that advertisers face today. In addition to allowing a user to opt-in, provide their information and give permission to advertiser(s) to access their information, embodiments disclosed herein enable the user to define what elements of personal data are available to the advertiser on an individual basis.

In some embodiments, digital advertisements (ads) can be bookmarked, categorized and stored via a personal storage and management application to allow the end user to manage and control the types of digital ads they wish to receive and use. Within this disclosure, the term “digital ads” is meant to encompass all types of documents and marketing materials used in electronic commerce (commonly known as e-Commerce), including offers, vouchers, rebates, coupons, and the like. For example, a digital ad can be delivered and presented to a consumer as or with a limited time offer on a particular product or service to entice the consumer to make a purchase by a certain date. Thus, the term “digital ads” as used in this disclosure is not limited to banner ads.

The personal storage and management application can be a web-based application, a thin client application, or a thick client application. Other implementations are also possible. For example, it may be implemented as a web service through a network site.

In some embodiments, digital ads may be delivered to a user and/or collected by the user's Internet connected device (also referred to as a client device. When an ad is viewed by the user, the user is given an option to bookmark the ad (by clicking on a graphical icon or “call to action” button within the ad) and save it via a personal storage and management application for future access and use. The client device achieves this by reading the embedded command code within the digital advertisement and bookmarks it utilizing the user's personalized storage and management application which provides automatic categorization based on the advertiser's metadata associated with the original advertisement. The metadata may include searchable keywords that can be used for categorization. In another embodiment the user may also save the digital ad through their client device including but limited to scanning of QR Codes, Barcodes and taking photographs.

The user can then log in to the personal storage and management application and review the bookmarked ads, manage and customize the categorization folders for future access, act upon the ads, and/or share the ads with their friend(s) and/or with their social network(s). The personal storage and management application can be tailored by the user to add additional personal data (such as types of products needed) to receive targeted digital advertisements that suit their individual needs and requirements.

Software implementing embodiments disclosed herein may be implemented in suitable computer-executable instructions that may reside on one or more non-transitory computer readable medium. Within this disclosure, the term “computer-readable storage medium” encompasses all types of data storage medium that can be read by a processor. Examples of computer-readable storage media can include random access memories, read-only memories, hard drives, data cartridges, magnetic tapes, floppy diskettes, flash memory drives, optical data storage devices, compact-disc read-only memories, and other appropriate computer memories and data storage devices.

Embodiments disclosed herein can provide many advantages. For example, the ability to interact, bookmark, categorize and store any ad campaign to access at a future time enables the advertiser to increase engagement with the user, thus increasing the Cost per Thousand (CPM) value of the advertisement to the advertising industry. It also gives the advertiser an effective (and legal) way of tracking and collecting information about the user based on the data the user is willing to provide, allowing the advertiser to create a one to one relationship with the user.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts an example of how a user can respond to a visual prompt provided within the embedded code of an ad to either view the full digital advertisement or bookmark and store the ad and any associated offer in the user's personal storage and management application together with automatic and/or manual categorization;

FIG. 2 depicts a flow chart of example processing steps for delivering a bookmarked ad to the user's personal storage and management application;

FIG. 3 depicts an example system for delivering ads over a network to a user device, illustrating a method for bookmarking, categorization and storing the ads and any associated offers via a personal storage and management application for later use by a user;

FIG. 4 depicts one example embodiment of a personal storage and management application, the application comprising a plurality of functions, including providing access to bookmarked and categorized ads and any associated offers, adding personal data for additional opt-in services with a chosen advertiser and brand, referral to a friend or a social network, rating an ad, requesting similar offers, personal data such as name, zip code, etc., and saving favorite brands sponsoring mini applications within the personal storage and management application; and

FIG. 5 depicts additional example functions of a personal storage and management application, including a first function for a user to create and manage folder categories, a second function for the user to add and manage personal data, and a third function for the user to control the use of their personal data on an individual case-by-case basis.

### DETAILED DESCRIPTION

The disclosure and various features and advantageous details thereof are explained more fully with reference to the exemplary, and therefore non-limiting, embodiments illustrated in the accompanying drawings and detailed in the following description. Descriptions of known programming techniques, computer software, hardware, operating platforms and protocols may be omitted so as not to unnecessarily obscure the disclosure in detail. It should be understood, however, that the detailed description and the specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like.

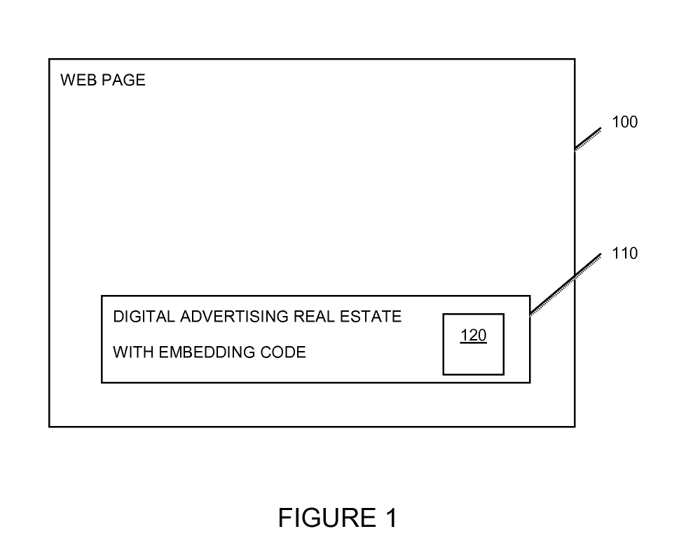

Digital advertising is available within the real estate (inventory) of many applications from websites to digital signage, mobile and tablet applications. The form in which the digital advertising is displayed within this inventory differs greatly. FIG. 1 illustrates one such example where webpage 100 of a network site is viewed by a user. Webpage 100 may include a banner or other digital ad 110 (also referred to herein as digital ad 110). Within this dedicated digital advertising area 110, an icon or call to action image 120 is displayed, providing a visual prompt for the user to respond.

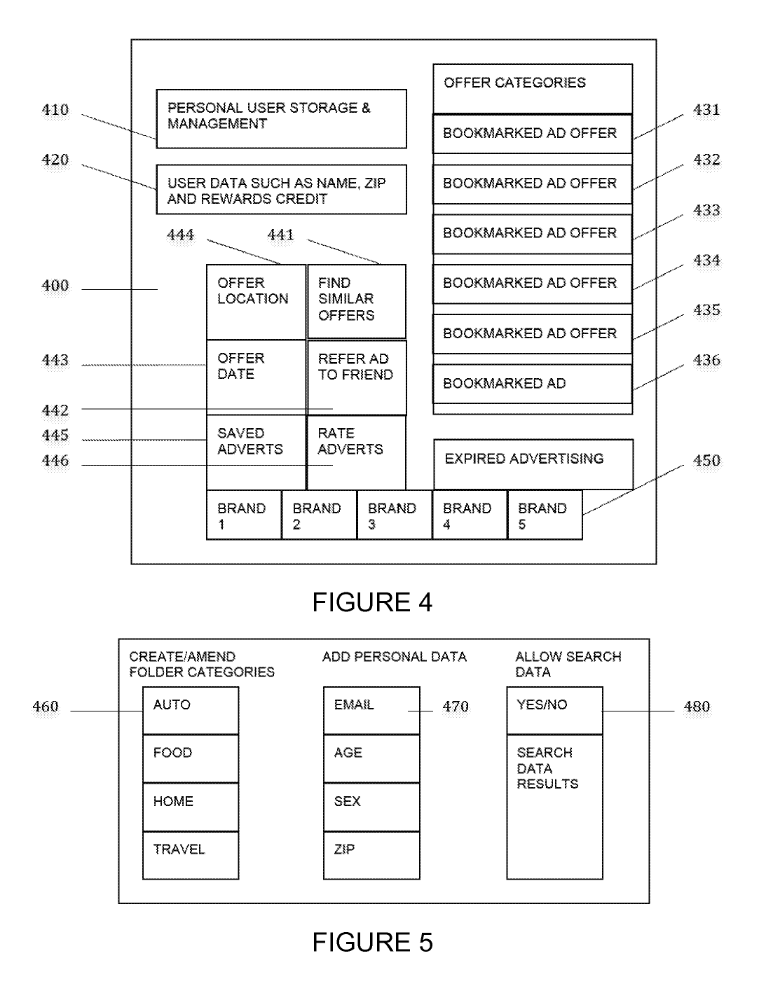

In some embodiments, call to action 120 may prompt the user to bookmark ad 110 into the user's personal storage and management application or may change to offer the user an ability to view a full size of the ad or save it for later use. The user may select, bookmark and categorize ad 110 and any given offers into the user's own personal storage and management application (see FIG. 4). Once the user clicks on ad 110 the embedded code within ad 110 may cause a window to pop up and provide the user with options to access the advertisement in full (which may be hosted at another network site). In some embodiments, after the user clicks on ad 110 the embedded code within ad 110 bookmarks and saves ad 110 and any associated offer into the user's personal storage and management application for later use.

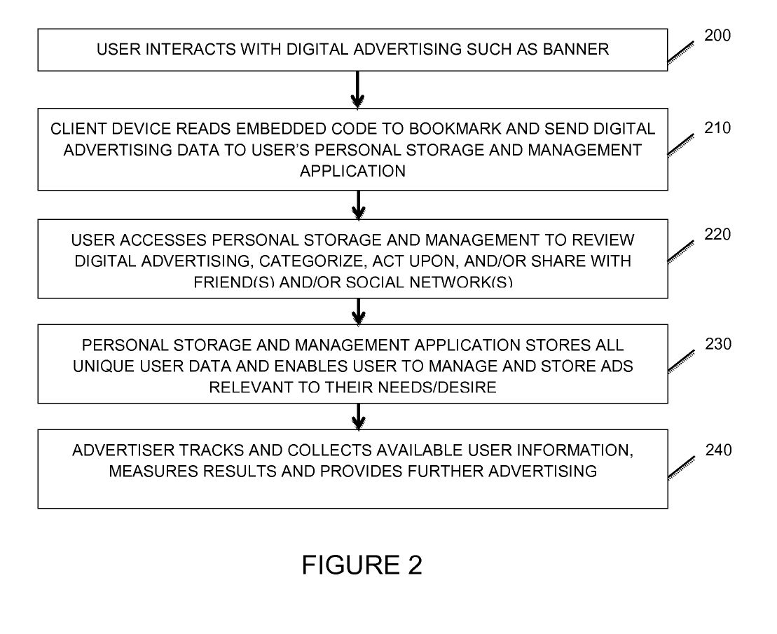

This use case is further illustrated in FIG. 2, which begins with the user interacting with the ad (step 200) via a user device. Suppose the user clicks on the call to action button to bookmark the ad. The user's action causes the user device to read, translate, or run the unique programming code embedded in the ad to bookmark and send data associated with the ad to the user's personal storage and management application (step 210). The user can access (log in) to the personal storage and management application to review the ad, categorize the ad, act upon the act, and/or share the ad with friend(s) and/or social network(s) (step 220). The personal storage and management application stores all the unique user data and enables the user to manage and store ads relevant to that user's individual needs and desire (step 230). Based on the user's settings within the personal storage and management application, advertisers can appropriately track and collect user information and provide further (and perhaps more targeted) ads (step 240).

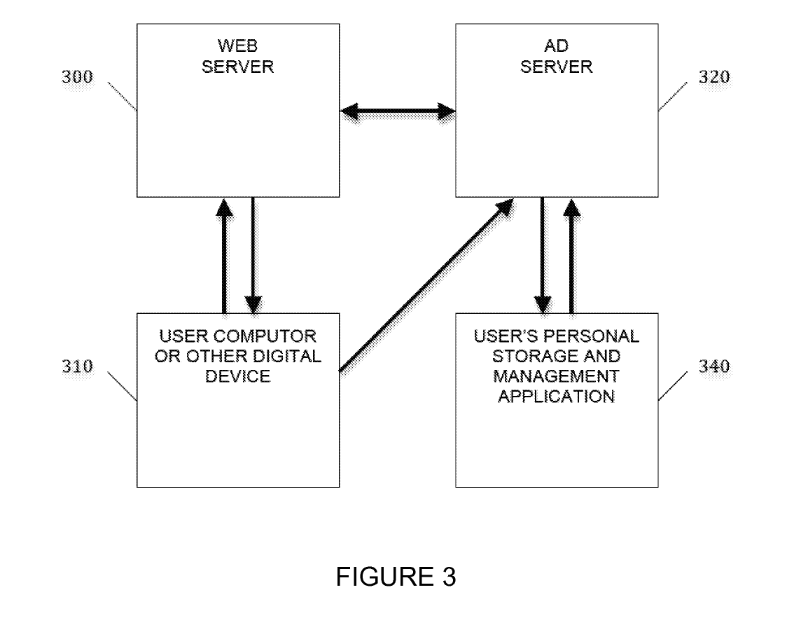

The bookmarking and storage of a selected digital ad begins as shown in FIG. 3 where web server 300 provides the content that is displayed on the user's Internet-enabled device 310. Ad server 320 is then able to deliver the ad into the inventory provided and render it into the area 110. Each ad created can include a dedicated call to action area 120 which allows the user to bookmark the digital advertisement and any associated offer into their personal storage and management application 340. The functionality of application 340 is further described below with reference to FIGS. 4 and 5. In some embodiments, the bookmarking is achieved through unique programming code embedded within call to action 120. In some embodiments, code associated with call to action 120 may allow the user to click and access the advertisement and any give offer or save it together with its unique metadata, categorization, time, date and location information provided from the original Ad Server location and other databases (including user's digital device and manually added information) into the user's personal storage and management application 340.

FIG. 3 represents a simplified network architecture for an example computing environment where embodiments disclosed herein may be implemented. As one skilled in the art can appreciate, the exemplary architecture shown and described herein with respect to FIG. 3 is meant to be illustrative and not limiting.

As illustrated in FIG. 3, web server 300, user device 310, Ad server 320, and application 340 may be implemented in a network environment such as the Internet. Web server 300, user device 310, Ad server 320, and application 340 can be bi-directionally coupled to a variety of networked systems, devices, repositories, etc.

The simplified network configuration shown in FIG. 3 may comprise at least a server machine and a client machine. Virtually any piece of hardware or electronic device capable of running client software and communicating with a server can be considered a client machine. As an example, user device 310 may include a central processing unit (CPU), a read-only memory (ROM), a random access memory (RAM), a hard drive (HD) or non-volatile memory, and input/output (I/O) device(s). An I/O device may be a keyboard, monitor, printer, electronic pointing device (e.g., mouse, trackball, etc.), or the like. The hardware configuration of user device 310 can be representative to other devices and computers alike in this network environment. Examples of network devices may include, but are not limited to desktop computers, laptop computers, personal digital assistants, handheld computers, cellular phones, and any electronic devices capable of storing and processing information and network communication.

Application 340 may implement an embodiment disclosed herein and may be communicatively coupled to a database, a data repository, and/or other data storage means. In some embodiments, application 340 may be implemented remote and/or local to user device 310. For example, a client version of application 340 may operate on user device 310 and store certain information locally when user device 310 is offline and may sync or otherwise upload the locally stored information to a server version of application 340 when user device 310 is online. Other implementations are also possible and anticipated. For example, application 340 may be implemented entirely as a web service available through web server 300 or ad server 320.

Embodiments disclosed herein may be implemented in suitable software including computer-executable instructions. As one skilled in the art can appreciate, a computer program product implementing an embodiment disclosed herein may comprise one or more non-transitory computer readable storage media storing computer instructions translatable by one or more processors. Examples of computer readable media may include, but are not limited to, volatile and non-volatile computer memories and storage devices such as ROM, RAM, HD, direct access storage device arrays, magnetic tapes, floppy diskettes, optical storage devices, etc. In an illustrative embodiment, some or all of the software components may reside on a single server computer or on any combination of separate server computers.

FIG. 4 depicts functional blocks of one example embodiment of user's personal storage and management application 400. A user can log in to application 400 through any number of Internet-enabled devices. After the user is authenticated, personalized user details may be displayed in section 410 together with user profile information in section 420. User profile 420 may include reward(s) that the user may have gained through participation in advertising campaign(s). Within application 400, the user is provided a method for categorizing and displaying all of the bookmarked digital advertisements offers collected previously 431 through 436. Additionally, various functional blocks enable the user to find similar campaign offers 441 and refer an offer to a friend or their social network 442.

In some embodiments, the functional blocks of personal storage and management application 400 may include temporal and locale tracking capabilities. For example, a timestamp process may be utilized to categorize the bookmarked digital advertisements for offer expiration date together with any other promotional information that may be time and date specific 443. A location-based process may be utilized to categorize the bookmarked digital ads for offer location(s). In some embodiments, this function can be provided nationally within the user's login country or locally within a certain selected distance, providing updates in real time depending on the user's location 444.

At all times the user can save the advertisements into a separate folder 445 for future reference and rate ads 446. The user's ad rating(s) can be communicated to an overall rating engine operating at a server computer. The rating engine may operate to compile data provided by various users and generate various ranking information based on actual user input. For example, the rating engine may rank the top rated, saved, and referred advertisements. This ranking information may be provided to personal storage and management application 400 and displayed to the user.

FIG. 5 depicts example post-collection ad management functions of a personal storage and management application, including a first function for a user to create and manage folder categories for bookmarked (collected) digital ads, a second function for the user to add and manage personal data, and a third function for the user to control the use of their personal data on an individual case-by-case basis. In some embodiments, these functions may be accessible via personal user storage and management function 410.

In some embodiments, personal storage and management application 400 can be further personalized to suit the user's taste and style, for instance, through color and images. In some embodiments, personal storage and management application 400 may allow one or more advertisers to sponsor a ‘mini application’ version, for instance, through white labeling and re-skinning of the application. In some embodiments, such mini applications can be displayed as favorite brands 450.

As FIG. 5 exemplifies, the user can select, change, rename and create new categorization folders using industry labeling together with their own customized labeling as desired 460. The user can also add additional personal data such as email address, age, sex, zip code, etc. and provide the personal data back to the advertiser on a case-by-case basis 470. The user can review all tracking and search data stored about the user and make this available to the advertiser on a case-by-case basis 480. For example, the user can pick and choose to send the user's age and gender information to an advertiser, but not the user's email address and zip code. This demographic information can be used by the advertiser in analyzing the performance of the ad relative to their target audience.

Additionally, personal storage and management application 400 may keep track of actions performed by the user which can infer the user's preference and/or buying habits. In one embodiment, personal storage and management application 400 may utilize persistent, non-session based data packets and a log file to track the user's browsing habits, including which pages the user has visited and in what sequence. Personal storage and management application 400 may provide the user with an option to send this information to an advertiser, allowing the advertiser to know more about the user in order to send targeted ads that are tailored to the user's preference and/or buying habits.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, assembly language, etc. Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

Furthermore, the term “or” as used herein is generally intended to mean “and/or” unless otherwise indicated. As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise.

1. A method of managing digital advertisements, the method comprising, on a processor, the steps of:
creating a first user interface displaying at least one digital advertisement;
determining if the user has interacted with the digital advertisement;
upon determining that the user has interacted with the digital advertisement, at least one of bookmarking the digital advertisement and saving the digital advertisement to a user's database of stored bookmarked and saved digital advertisements; and
creating a second user interface displaying at least one digital advertisement stored in the database.

2. The method of claim 1, further comprising obtaining a selection of digital advertisements stored in the database for sharing with third parties and transmitting the selected digital advertisements to the third parties.

3. The method of claim 1, further comprising displaying a full size advertisement upon determining that the user has interacted with the digital advertisement.

4. The method of claim 1, further comprising:
obtaining a selection of digital advertisements stored in the database for categorization;
obtaining a selection of a category to categorize the selected digital advertisements into; and
associating the selected digital advertisements with the selected category.

5. The method of claim 1, wherein the first and second user interfaces are transmitted via the Internet to a client device.

6. The method of claim 1, wherein the at least one digital advertisement displayed by the first user interface comprises at least one interactive component.

7. The method of claim 1, further comprising reporting to an advertiser if a user has interacted with the digital advertisement.

8. The method of claim 1, further comprising creating a third user interface, wherein the user provides profile data.

9. The method of claim 8, further comprising obtaining a selection of profile data to be shared with advertisers.

10. A system of managing digital advertisements, comprising:
a processor;
a networking device coupled to the processor and in communication with at least one client device; and
software executing on the processor, wherein the software:
creates a first user interface displaying at least one digital advertisement;
determines if the user has interacted with the digital advertisement;
upon determining that the user has interacted with the digital advertisement, at least one of bookmarks the digital advertisement and saves the digital advertisement to a user's database of stored bookmarked and saved digital advertisements; and
creates a second user interface displaying at least one digital advertisement stored in the database.

11. The system of claim 10, wherein the software obtains a selection of digital advertisements stored in the database for sharing with third parties and transmits the selected digital advertisements to the third parties.

12. The system of claim 10, wherein the software displays a full size advertisement upon determining that the user has interacted with the digital advertisement.

13. The system of claim 10, wherein the software further:
obtains a selection of digital advertisements stored in the database for categorization;
obtains a selection of a category to categorize the selected digital advertisements into; and
associates the selected digital advertisements with the selected category.

14. The system of claim 10, wherein software transmits the first and second user interfaces via the Internet to the client device.

15. The system of claim 10, wherein the at least one digital advertisement displayed by the first user interface comprises at least one interactive component.

16. The system of claim 10, wherein the software reports to an advertiser if a user has interacted with the digital advertisement.

17. The system of claim 10, wherein the software creates a third user interface, wherein the user provides profile data.

18. The system of claim 17, wherein the software obtains a selection of profile data to be shared with advertisers.

19. A computer-readable media containing program instructions for managing digital advertisements, that causes a processor to:
create a first user interface displaying at least one digital advertisement;
determine if the user has interacted with the digital advertisement;
upon determining that the user has interacted with the digital advertisement, at least one of bookmark the digital advertisement and save the digital advertisement to a user's database of stored bookmarked and saved digital advertisements; and
create a second user interface displaying at least one digital advertisement stored in the database.

20. The computer-readable media of claim 19, wherein the computer-readable media further causes the processor to obtain a selection of digital advertisements stored in the database for sharing with third parties and transmit the selected digital advertisements to the third parties.

21. The computer-readable media of claim 19, wherein the computer-readable media further causes the processor to display a full size advertisement upon determining that the user has interacted with the digital advertisement.

22. The computer-readable media of claim 19, wherein the computer-readable media further causes the processor to:
obtain a selection of digital advertisements stored in the database for categorization;
obtain a selection of a category to categorize the selected digital advertisements into; and
associate the selected digital advertisements with the selected category.

23. The computer-readable media of claim 19, wherein the first and second user interfaces are transmitted via the Internet to a client device.

24. The computer-readable media of claim 19, wherein the at least one digital advertisement displayed by the first user interface comprises at least one interactive component.

25. The computer-readable media of claim 19, wherein the computer-readable media further causes the processor to report to an advertiser if a user has interacted with the digital advertisement.

26. The computer-readable media of claim 19, wherein the computer-readable media further causes the processor to create a third user interface, wherein the user provides profile data.

27. The computer-readable media of claim 26, wherein the computer-readable media further causes the processor to obtain a selection of profile data to be shared with advertisers.
